(19) United States
(12) Patent Application Publication
(10) Pub. No.: US 2025/0292396 A1
(43) Pub. Date: Sep. 18, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: SHO IKEMOTO, Kanagawa (JP)

(21) Appl. No.: 19/078,084

(22) Filed: Mar. 12, 2025

(30) Foreign Application Priority Data
Mar. 14, 2024 (JP) 2024-040549

(51) Int. Cl. G06T 7/00

(52) U.S. Cl. CPC G06T 7/001; G06T 2207/10012; G06T 2207/10024; G06T 2207/20212; G06T 2207/30108

(57) ABSTRACT

An image processing apparatus includes at least one processor and at least one memory that is in communication with the at least one processor. The at least one memory stores instructions for causing the at least one processor and the at least one memory to acquire captured images obtained by imaging an object; determine whether the number of the acquired captured images is a reference number for an inspection of the object; in a case where it is determined that the number of the acquired captured images is the reference number, detect a defect in the object based on the acquired captured images; and in a case where it is determined that the number of the acquired captured images is not the reference number, output a warning.

### BACKGROUND

### Field of the Disclosure

The present disclosure relates to an image processing technique for inspecting objects.

### Description of the Related Art

As an appearance inspection technique for industrial products, there has been a known method of detecting asperities in inspection surfaces. Japanese Patent Application Laid-Open No. 2015-232480 discloses a technique for combining a plurality of images obtained by imaging inspection target objects using a photometric stereo method to determine whether the target objects are good or bad.

For some types of industrial products, the quantity of production per unit time may be large, and the time available for each inspection may be short. In this case, high-speed imaging is performed, but the number of images obtained by continuous imaging can vary depending on settings of the imaging apparatus, communication conditions, and other conditions. A greater or smaller number of images captured than desired can cause decreased inspection accuracy.

### SUMMARY

In view of this, some embodiments of the present disclosure are directed to reduction of decrease in inspection accuracy caused by a change in the number of captured images.

According to an aspect of the present disclosure, an image processing apparatus includes at least one processor and at least one memory that is in communication with the at least one processor. The at least one memory stores instructions for causing the at least one processor and the at least one memory to acquire captured images obtained by imaging an object; determine whether the number of the acquired captured images is a reference number for an inspection of the object; in a case where it is determined that the number of the acquired captured images is the reference number, detect a defect in the object based on the acquired captured images; and in a case where it is determined that the number of the acquired captured images is not the reference number, output a warning.

Further features of various embodiments will become apparent from the following description of exemplary embodiments with reference to the attached drawings.

### BRIEF DESCRIPTION OF THE DRAWINGS

FIGS. 1A to 1C are diagrams illustrating outer appearances and the hardware configuration of an appearance inspection system.

FIG. 2 is a diagram illustrating a functional configuration of the appearance inspection system.

FIG. 3 is a flowchart of processing in an image processing system.

FIG. 4 is a table illustrating a lighting unit.

FIG. 5 is a diagram illustrating an example of a user interface.

FIG. 6 is a table illustrating numbers of captured images used for inspections.

FIG. 7 is a flowchart of processing in the image processing system.

FIG. 8 is a flowchart of processing in the image processing system.

FIG. 9 is a table illustrating numbers of captured images used for inspections.

### DESCRIPTION OF THE EMBODIMENTS

Some exemplary embodiments will now be described with reference to the drawings. The following exemplary embodiments do not necessarily limit every embodiment of the present disclosure. Furthermore, not all of the combinations of features described in the exemplary embodiments are used in solving means of the present disclosure.

A first exemplary embodiment will be described. A greater or smaller number of images captured than desired on an inspection based on image data obtained by imaging an inspection target object can cause decreased inspection accuracy. For example, when the number of images captured is small, sufficient images are not obtained to apply the photometric stereo method. This makes it difficult to estimate the surface shape of an inspection target object with high accuracy. When the number of images captured is large, the images may be dark because the imaging and the lighting of the light source are not well synchronized. This makes it impossible to detect defects on the surface shape of an inspection target object with high accuracy. In the present exemplary embodiment, a warning is issued to a user when the number of images captured by imaging does not meet a desired number. This prevents decrease in inspection accuracy caused by execution of inspections in situations where numbers of images captured are more or less than desired numbers.

### <Outer Appearance and Hardware Configuration of Appearance Inspection System>

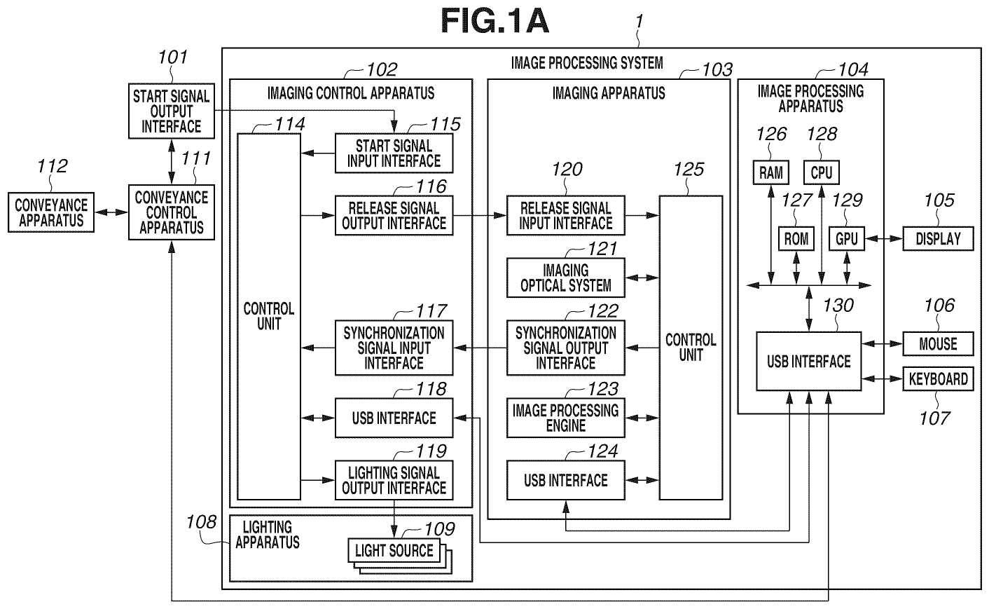

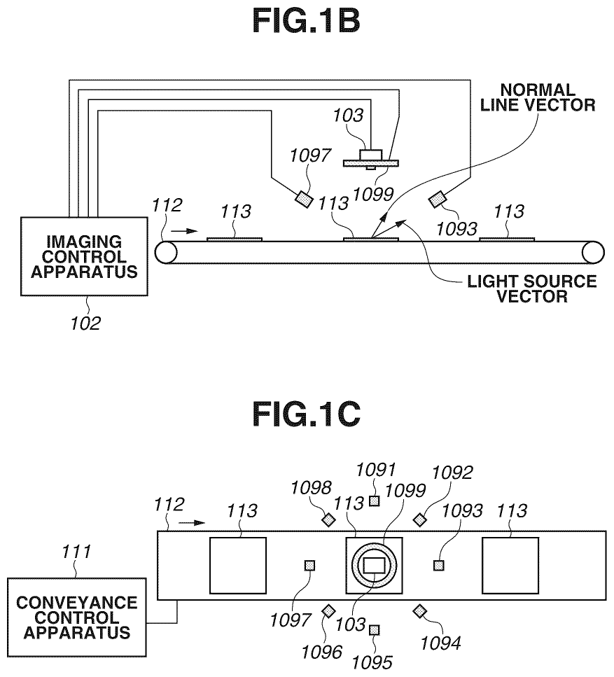

FIG. 1A is a diagram illustrating a hardware configuration example of an appearance inspection system in the present exemplary embodiment. FIG. 1B is a front view of the general appearance of the appearance inspection system. FIG. 1C is a top view of the general appearance of the appearance inspection system. The appearance inspection system in the present exemplary embodiment includes an image processing system 1, a start signal output interface 101, a conveyance control apparatus 111, and a conveyance apparatus 112.

The image processing system 1 includes an imaging control apparatus 102, an imaging apparatus 103, an image processing apparatus 104, a display 105, a mouse 106, a keyboard 107, and a lighting apparatus 108. The image processing system 1 is connected to the conveyance control apparatus 111 that controls the conveyance apparatus 112. The conveyance control apparatus 111 conveys an object 113 to be inspected to the image processing system 1 with the conveyance apparatus 112, and sends an inspection start signal to the image processing system 1 via the start signal output interface 101.

The imaging control apparatus 102 includes a control unit 114 that controls the imaging apparatus 103 and the lighting apparatus 108 to capture images of the object 113 in synchronization with lightings of light sources. In detail, upon receipt of an inspection start signal from a start signal input interface 115, the imaging control apparatus 102 issues an imaging instruction to the imaging apparatus 103 via a release signal output interface 116. The imaging control apparatus 102 also receives a synchronization signal from the imaging apparatus 103 via a synchronization signal input interface 117 to notify a light emission timing to an external strobe light source in synchronization with an imaging. Furthermore, the imaging control apparatus 102 turns on the light sources 109 of the lighting apparatus 108 in a predetermined order and combination in response to the received synchronization signal via a lighting signal output interface 119. The above operation makes it possible to capture an image of the object 113 lit by a predetermined illumination. In the present exemplary embodiment, a lighting of the light sources 109 and an imaging are synchronized based on the synchronization signal output from the imaging apparatus 103, but the method of synchronization between a lighting of the light sources 109 and an imaging is not limited to the above example. For example, a pulse signal can be output from the control unit 114 to simultaneously output an imaging instruction to the imaging apparatus 103 and a light source lighting instruction to the lighting apparatus 108. The imaging control apparatus 102 is connected to the image processing apparatus 104 via a universal serial bus (USB) interface 118, receives commands from the image processing apparatus 104 and provides information indicating states of the imaging control apparatus 102 to the image processing apparatus 104.

The imaging apparatus 103 includes a control unit 125, and an imaging optical system 121 including a lens and an imaging element. The imaging apparatus 103 obtains an optical image by an imaging in response to an imaging instruction received via a release signal input interface 120 and quantizes the optical image with an image processing engine 123 to generate a captured image. The imaging apparatus 103 transfers the generated captured image to the image processing apparatus 104 via a USB interface 124. While still images are captured using a digital camera in the present exemplary embodiment as an example, moving images can be captured using a video camera, and predetermined frames can be extracted as still images from the moving images.

The imaging apparatus 103 sends a synchronization signal to the imaging control apparatus 102 via a synchronization signal output interface 122.

The image processing apparatus 104 includes a random access memory (RAM) 126, a read only memory (ROM) 127, a central processing unit (CPU) 128, a graphics processing unit (GPU) 129, and a USB interface 130. These components are connected via an internal bus. Program codes of the processing in a flowchart described below are stored in the ROM 127.

The program codes are loaded in the RAM 126 and executed by the CPU 128 and the GPU 129.

The lighting apparatus 108 includes a plurality of light sources 109. In the present exemplary embodiment, the light sources 109 are light-emitting diodes (LEDs), but can be other light sources, such as xenon lamps. The plurality of light sources 109 is disposed in a hemispherical distribution pattern above the object 113, and different from one another in at least the zenith angle or the azimuth angle. In an inspection using captured images, the light irradiation method is changed based on the appearance inspection item. For example, in inspecting the gloss of an object, light irradiation is applied to the inspection surface from a direction that allows specularly-reflected light to be imaged. In inspecting the color or surface shape of an object, light irradiation is applied to the inspection surface from a direction that does not allow specularly-reflected light to be imaged. Thus, some of the light sources 109 are disposed in a direction with a large angle of incidence with respect to the placement surface of the object 113, which enables imaging under geometric conditions where the imaging apparatus 103 easily receives diffusion-reflected light. In addition, some of the light sources 109 are disposed in a direction with a small angle of incidence with respect to the placement surface of the object 113, which enables imaging under geometric conditions where the imaging apparatus 103 easily receives specularly-reflected light. The light sources 109 may have different light-emitting surfaces and spectral characteristics independently. For example, spot illumination devices, such as light sources 1091 to 1098, can be installed in a direction with a large angle of incidence with respect to the placement surface of the object 113, and ring illumination devices in which light-emitting elements are arranged in a circular ring, such as a light source 1099, can be installed in a direction with a small angle of incidence. In response to a command from the control unit 114, the lighting apparatus 108 turns on predetermined ones of the light sources 109 for a predetermined period of time.

In the image processing system 1 of the present exemplary embodiment, the imaging control apparatus 102, the imaging apparatus 103, the image processing apparatus 104, and the lighting apparatus 108 are separate apparatuses, but two or more of these apparatuses can be integrated together.

### <Processing Executed by Image Processing System>

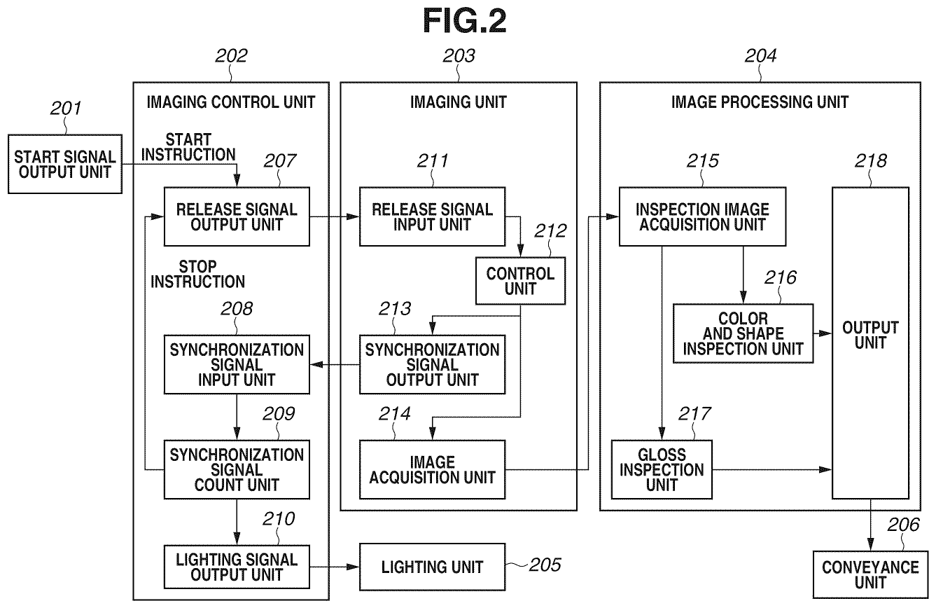

FIG. 2 is a diagram illustrating a functional configuration example of the appearance inspection system in the present exemplary embodiment. The control unit 114 of the imaging control apparatus 102 includes an imaging control unit 202. The imaging control unit 202 includes a release signal output unit 207, a synchronization signal input unit 208, a synchronization signal count unit 209, and a lighting signal output unit 210. The control unit 125 of the imaging apparatus 103 includes an imaging unit 203. The imaging unit 203 includes a release signal input unit 211, a control unit 212, a synchronization signal output unit 213, and an image acquisition unit 214. The image processing apparatus 104 includes an image processing unit 204. The image processing unit 204 includes an inspection image acquisition unit 215, a color and shape inspection unit 216, a gloss inspection unit 217, and an output unit 218. The conveyance control apparatus 111 includes a start signal output unit 201. The conveyance apparatus 112 includes a conveyance unit 206. The lighting apparatus 108 includes a lighting unit 205.

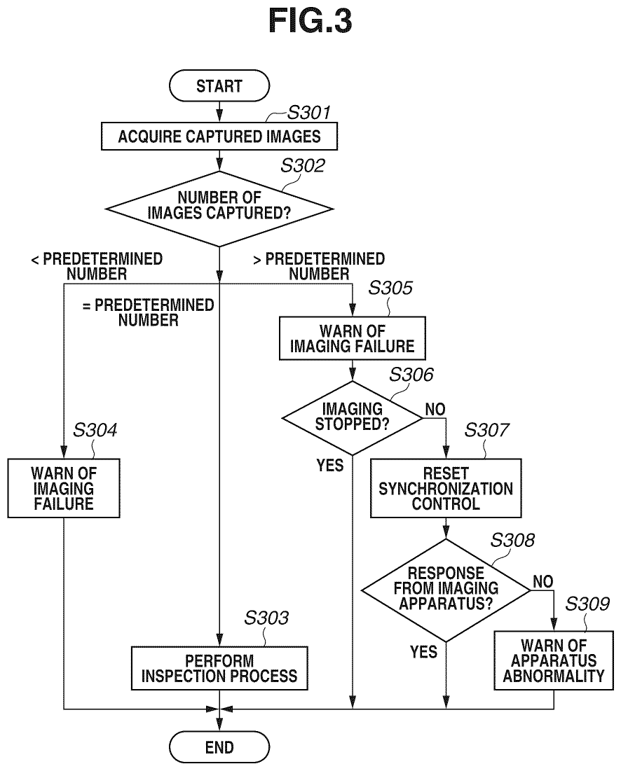

FIG. 3 is a flowchart of the process executed by the image processing system 1 in the present exemplary embodiment. When the object 113 is conveyed to a predetermined position by the conveyance apparatus 112, the start signal output unit 201 of the conveyance control apparatus 111 sends an inspection start signal to the imaging control unit 202. The process in FIG. 3 is started when the imaging control unit 202 receives the inspection start signal.

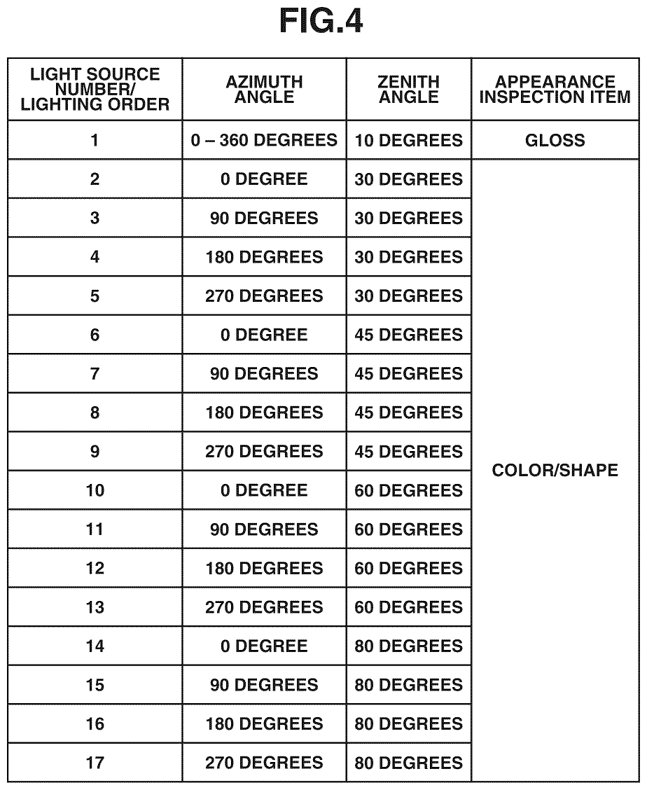

In step S301, the imaging control unit 202 and the imaging unit 203 acquire a plurality of images captured by turning on predetermined light sources and capturing images of the object 113 to be inspected, and transfer the images to the image processing unit 204. Specifically, the release signal output unit 207 that has received an inspection start signal sends a release signal to the release signal input unit 211. Upon detecting the release signal received by the release signal input unit 211, the control unit 212 executes an imaging operation. In the present exemplary embodiment, high-speed continuous imaging is performed using a known continuous imaging function. The continuous imaging function refers to a function to repeat an imaging at a predetermined speed while release signals are sent continuously. In the present exemplary embodiment, an imaging is performed at 30 frames per second. During the imaging, the control unit 212 causes the synchronization signal output unit 213 to output a synchronization signal in order to synchronize a light emission timing of the external strobe light source with a timing at which the shutter curtain opens. When the synchronization signal input unit 208 inputs a synchronization signal, the synchronization signal count unit 209 counts the number of synchronization signal inputs, in other words, the number of images captured. The lighting signal output unit 210 switches the light sources to be turned on in sequence based on the number of images captured, and outputs lighting signals to the lighting unit 205. FIG. 4 illustrates the installation angles and order of turning on the lighting unit 205 in the present exemplary embodiment. The number, arrangement, and lighting order of the light sources are not limited to the example in FIG. 4. A circular ring illumination device is used as the light source corresponding to light source number 1 to emit light onto the inspection surface from all azimuth angles. The image acquisition unit 214 repeatedly transfers, as appropriate, the images captured by turning on predetermined light sources and capturing images of the object 113 to be inspected to the inspection image acquisition unit 215. With the above processing, in step S301, the imaging control unit 202 and the imaging unit 203 can transfer the plurality of captured images to the image processing unit 204.

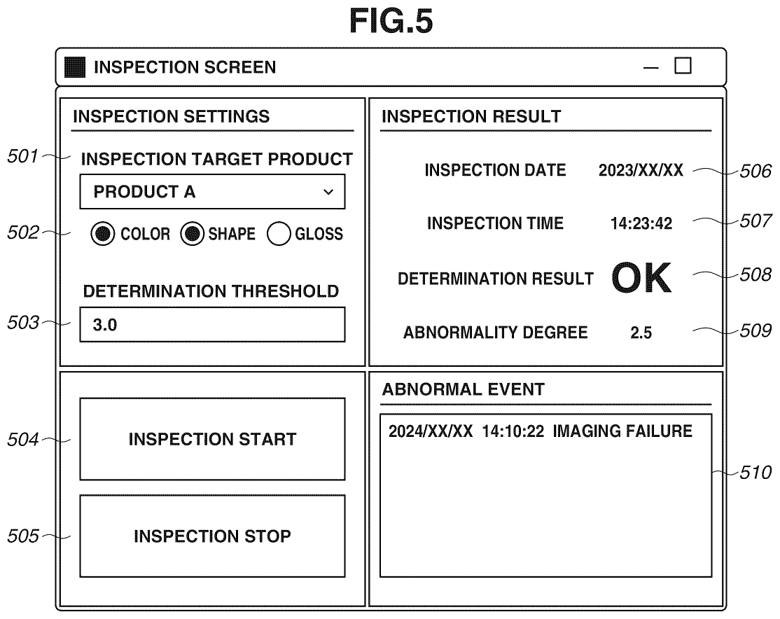

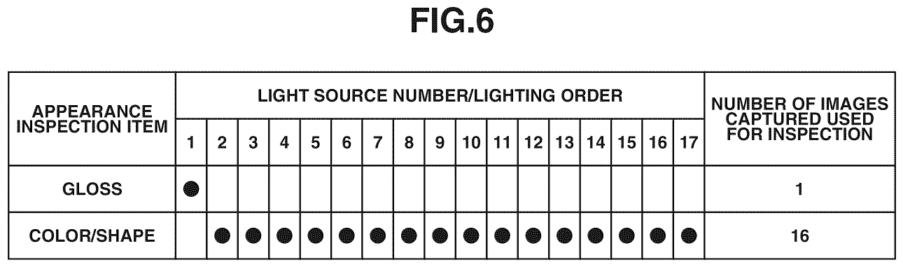

In step S302, the inspection image acquisition unit 215 compares the number of images captured acquired with a reference number indicating the number of images captured used for inspection. Specifically, the inspection image acquisition unit 215 first sets a reference number to be used for comparison based on the settings of the appearance inspection items. The appearance inspection items in the present exemplary embodiment fall into three types: color, surface shape, and gloss. The appearance inspection items are not limited to the above example, and can be anything as long as the item represents the appearance and can be distinguished in captured images. For example, material or pattern may be used. The inspection image acquisition unit 215 displays an inspection screen user interface (UI) illustrated in FIG. 5 on the display 105 and accepts instructions from a user. One or more types of appearance inspection items are set in the inspection screen UI illustrated in FIG. 5. The user can perform inputs via the inspection screen UI displayed on the display 105 using the mouse 106 or the keyboard 107. When an inspection target product is selected from a plurality of products in a drop-down menu registered in advance in a product selection area 501, the appearance inspection items based on the selected inspection target product are set in an item setting area 502. The user can change the appearance inspection items via a radio button/radio buttons selected in the item setting area 502. As illustrated in FIG. 4, there is a correspondence between the light sources to be turned on during imaging and the appearance inspection items. As illustrated in FIG. 6, the inspection image acquisition unit 215 sets numbers of images captured used for appearance inspection items to reference numbers.

For example, the reference numbers are set as one or more for a gloss inspection, and three or more for a color or surface shape inspection. The reference numbers can be changed based on the inspection target product. On the inspection screen UI, the inspection date is displayed in an inspection date area 506, and the inspection time is displayed in an inspection time area 507.

The inspection image acquisition unit 215 compares the number of images captured with the set reference number to determine whether the number of images captured meets the number of images to be used for inspection. If the number of images captured meets the number of images to be used for inspection, the process proceeds to step S303. If the number of images captured is less than the number of images to be used for inspection, the process proceeds to step S304. If the number of images captured is more than the number of images to be used for inspection, the process proceeds to step S305. The determination of the number of images captured in step S302 is made at a time interval during which an image inspection is carried out, namely, at a takt time during which the inspection target product is produced. However, a timing for completing an imaging, such as the start and end of the inspection, can be input from an external device.

In step S303, the color and shape inspection unit 216 and the gloss inspection unit 217 conduct an inspection process. The color and shape inspection unit 216 detects defects by performing spatial filtering processing on the inspection image including normal line information and color information obtained by the combined captured images using the photometric stereo method. The color and shape inspection unit 216 integrates and quantifies the reaction value to the spatial filter to determine a degree of abnormality, and determines whether to pass or fail the inspection by comparing the degree of abnormality with a determination threshold. The calculated degree of abnormality is displayed in an abnormality display area 509 of the inspection screen UI illustrated in FIG. 5. The determination threshold can be set in a threshold setting area 503 of the inspection screen UI illustrated in FIG. 5. The gloss inspection unit 217 detects defects by performing spatial filtering processing in the same manner as above on the captured images obtained by receiving specularly-reflected light from the inspection surface of the object as an inspection image with gloss information. The photometric stereo method combines captured images corresponding to a plurality of lighting directions to obtain normal line information representing the surface shape of an object and color information representing the color of an object. The above inspection process method is an example, and other inspection methods can be used.

The output unit 218 displays the results of inspection processing on the display 105. For example, on the inspection screen UI illustrated in FIG. 5, if the inspection surface of an object passes the inspection, “OK” is displayed in the determination result area 508, and if the inspection surface of an object does not pass the inspection, “NG” is displayed in the determination result area 508. Furthermore, the output unit 218 outputs conveyance instructions to the conveyance unit 206 to convey approved products and rejected products after the inspections to the subsequent step.

In step S304, the output unit 218 displays a warning or warnings of the imaging failure in the determination result area 508 and an abnormal event display area 510. For example, “NR (No Read)” indicating that the inspection will not be conducted is displayed in the determination result area 508. The imaging failure can be notified by turning on a not-illustrated stack light. If the process proceeds to step S304, the inspection on the inspection target product is not conducted due to the imaging failure. Thus, the inspection target product is distinguished from the approved products and the rejected products, an instruction for the inspection target product as an imaging failure product to be conveyed to the subsequent step is issued to the conveyance unit 206, and the inspection target product is subjected to an inspection performed by an inspection apparatus or visual inspection.

In step S305, similarly in step S304, the output unit 218 displays a warning or warnings of the imaging failure in the determination result area 508 and the abnormal event display area 510. Thereafter, in step S306, the output unit 218 determines whether an imaging by the imaging apparatus 103 is stopped. Specifically, the output unit 218 determines whether a signal from the release signal output unit 207 is in a release state or whether captured images are being continuously transferred from the imaging unit 203 to the image processing apparatus 104.

If the imaging is stopped (YES in step S306), the process is ended. If the imaging is not stopped (NO in step S306), the image processing system 1 is not operating normally. Thus, in step S307, the output unit 218 resets and returns the imaging control unit 202 to the initial state. In the initial state of the imaging control unit 202, a signal from the release signal output unit 207 is off, where the imaging control unit 202 is waiting for the input of an inspection start signal from the conveyance control apparatus 111. In step S308, the output unit 218 checks a response state of the imaging apparatus 103. Specifically, the output unit 218 determines whether the control unit 125 of the imaging apparatus 103 correctly responds to a command from the image processing apparatus 104. If the control unit 125 of the imaging apparatus 103 correctly responds to the command from the image processing apparatus 104 (YES in step S308), it is determined that no abnormality occurs in the imaging apparatus 103, and the process is ended. If the control unit 125 of the imaging apparatus 103 does not respond correctly to the command from the image processing apparatus 104 (NO in step S308), the output unit 218 determines that an abnormality occurs in the imaging apparatus 103, and displays a warning or warnings of the apparatus abnormality in the determination result area 508 and the abnormal event display area 510. For example, “ER (Error)” indicating an apparatus malfunction is displayed in the determination result area 508. Further, a non-illustrated stack light can be turned on to notify the apparatus malfunction. In the event of an apparatus abnormality, the output unit 218 displays information urging a recovery operation, such as an inspection or a restart of the image processing system 1. For example, the selection of an inspection start button 504 or an inspection stop button 505 performs a restart process, allowing the image processing system 1 to be restored to an inspection standby state.

As described above, as the number of images captured fluctuates, the image processing system 1 in the present exemplary embodiment regards the inspection target product as an imaging failure product and issues an instruction of conveying the defective product to the subsequent step, and checks for apparatus abnormality as appropriate. This prevents decrease in inspection accuracy when the number of captured images fluctuates.

A second exemplary embodiment will now be described. In the first exemplary embodiment, when the number of images captured fluctuates, an inspection target product is regarded as an imaging failure product and an instruction is issued to convey the imaging failure product to the subsequent step. In the second exemplary embodiment, even when the number of images captured fluctuates, an inspection is conducted as long as conditions that do not affect the inspection accuracy are satisfied. This prevents decrease in the yield caused by the inability to inspect due to a change in the number of images captured. The configuration of an image processing system 1 in the present exemplary embodiment is the same as that in the first exemplary embodiment, and thus, the description thereof will be omitted. The following description will focus on differences between the present exemplary embodiment and the first exemplary embodiment. The same components as those in the first exemplary embodiment will be described using the same reference numerals.

### <Processing Executed by Image Processing System>

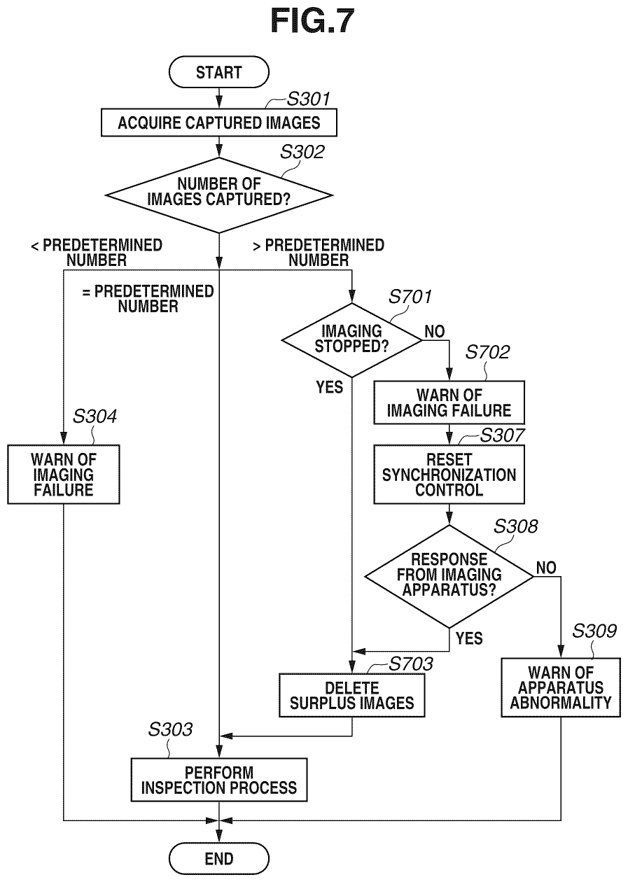

FIG. 7 is a flowchart of processing executed by the image processing system 1 in the present exemplary embodiment. When the object 113 is conveyed to a predetermined position by the conveyance apparatus 112, the start signal output unit 201 of the conveyance control apparatus 111 sends an inspection start signal to the imaging control unit 202. The processing in FIG. 7 is started when the imaging control unit 202 receives the inspection start signal. Steps S301 to S304 and S307 to S309 are the same as those in the first exemplary embodiment.

In step S701, an output unit 218 determines whether the imaging by the imaging apparatus 103 is stopped. Specifically, the output unit 218 determines whether the signal from the release signal output unit 207 is in a release state, or whether captured images are being continuously transferred from the imaging unit 203 to the image processing apparatus 104. If the imaging is not stopped (NO in step S701), the process proceeds to step S702. If the imaging is stopped (YES in step S701), the process proceeds to step S703.

In step S702, the output unit 218 displays a warning or warnings of the imaging failure in the determination result area 508 and the abnormal event display area 510. For example, “NR (No Read)” indicating that the inspection will not be conducted is displayed in the determination result area 508. The imaging failure can be notified by turning on a not-illustrated stack light. If the process proceeds to step S702, the inspection is not conducted due to the imaging failure. Thus, the inspection target product is distinguished from the approved products and the rejected products, an instruction for the inspection target product as an imaging failure product to be conveyed to the subsequent step is issued to the conveyance unit 206, and the inspection target product is subjected to an inspection performed by an inspection apparatus or visual inspection. The process then proceeds to step S308.

In step S703, when the number of captured images is large and the imaging is stopped, the inspection image acquisition unit 215 deletes excessive images. In step S303, the color and shape inspection unit 216 and the gloss inspection unit 217 execute the inspection process using up to the number of images captured normally. The increase in the number of images captured due to the continuous imaging function of the imaging apparatus 103 is attributed to release time lags or fluctuation in timings for determining the duration of continuous imaging, resulting in excessive imaging at the end of normal imaging. Thus, the inspection image acquisition unit 215 identifies the 17th and subsequent captured images as excessive images and deletes the images. In the present exemplary embodiment, excessive images are identified based on the order of imaging, but excessive images can be identified based on characteristics of the captured images. For example, images with low average luminance among captured images can be deleted as excessive images. This is because when excessive imaging is performed, the light sources are not turned on in synchronization and relatively dark images are captured. The number of images captured can be set as more than the number of images captured as desired. This is because an insufficient number of images captured affects the inspection accuracy, but if an excessive number of images are captured, the inspection accuracy is not affected depending on the condition.

As described above, even when the number of images captured fluctuates, the image processing system 1 in the present exemplary embodiment conducts an inspection as long as the conditions that do not affect the inspection accuracy are satisfied. This prevents decrease in the yield caused by the inability to conduct an inspection due to a change in the number of images captured.

A third exemplary embodiment will now be described. In the second exemplary embodiment, even when the number of images captured fluctuates, an inspection is conducted as long as the conditions that do not affect the inspection accuracy are satisfied. In the third exemplary embodiment, even when the number of images captured fluctuates, an inspection is conducted as long as the conditions that minimally affect the inspection accuracy are satisfied. This further prevents decrease in the yield caused by the inability to inspect due to a change in the number of images captured. The configuration of the image processing system 1 in the present exemplary embodiment is the same as that in the first exemplary embodiment, and thus, the description thereof will be omitted. The following description will focus on differences between the present exemplary embodiment and the first and second exemplary embodiments. The same components as those in the first and second exemplary embodiments will be described with the same reference numerals.

### <Processing Executed by Image Processing System>

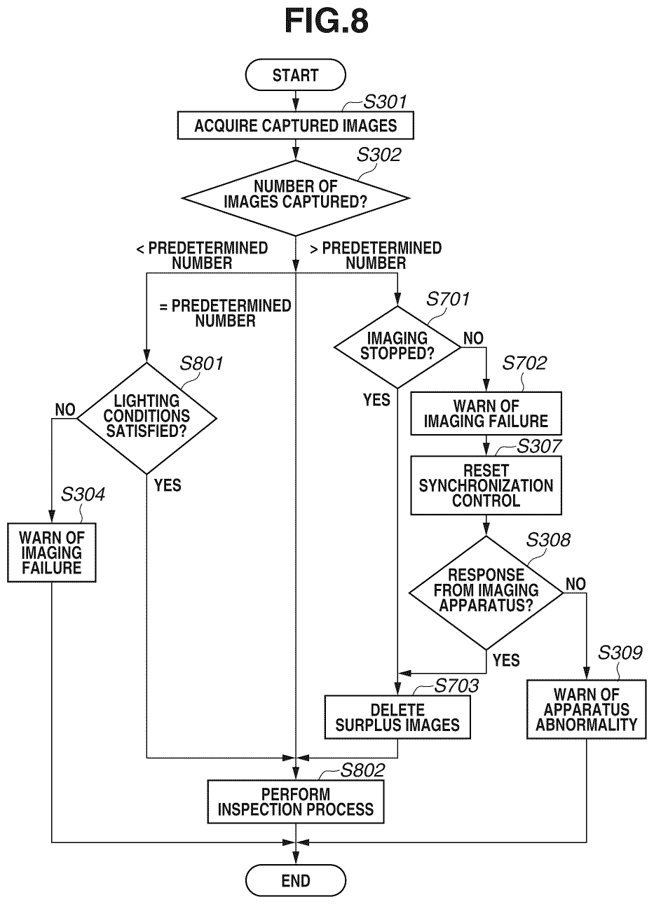

FIG. 8 is a flowchart of processing executed by the image processing system 1 in the present exemplary embodiment. When the object 113 is conveyed to a predetermined position by the conveyance apparatus 112, the start signal output unit 201 of the conveyance control apparatus 111 sends an inspection start signal to the imaging control unit 202. The processing in FIG. 8 is started when the imaging control unit 202 receives the inspection start signal. Steps S301, S302, S304, and S307 to S309 are the same as those in the first exemplary embodiment, and steps S701 to S703 are the same as those in the second exemplary embodiment.

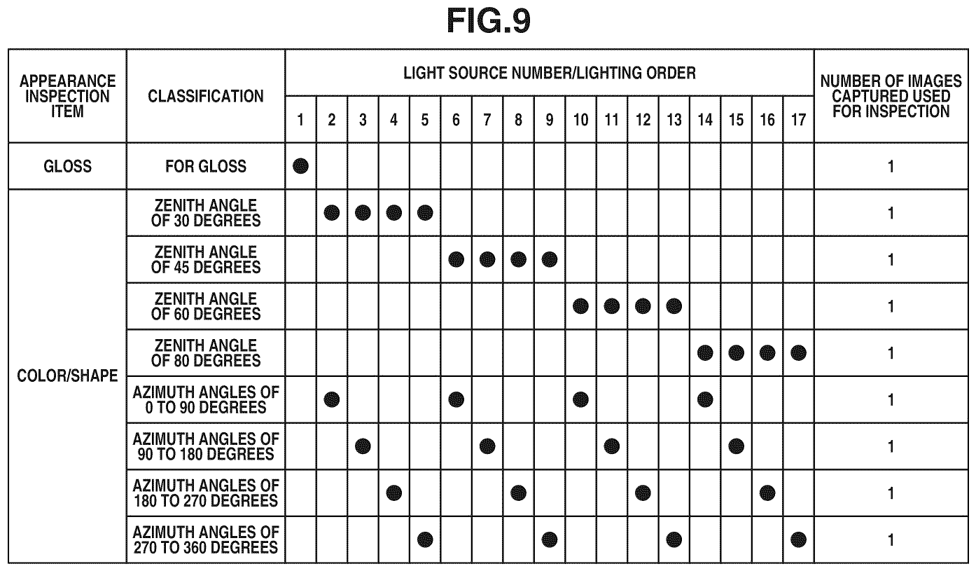

In step S801, the inspection image acquisition unit 215 determines whether lighting conditions based on appearance inspection items are satisfied. FIG. 9 illustrates an example of the lighting conditions based on the appearance inspection items. To generate an inspection image using the photometric stereo method, in principle, three or more images of an object irradiated with light from diverse directions are used. Thus, if the appearance inspection items are color and shape, reference numbers, which are numbers of images captured used for inspections, are set based on the directions of the zenith angle and azimuth angle. Even though an image corresponding to light irradiation from a certain direction fails to be captured while an image corresponding to light irradiation from a nearby direction exists, an inspection image can be generated with minimal information loss, making possible the execution of an inspection process.

To increase the probability that the inspection process can be performed, it is desirable to turn on the light sources used for an inspection in order of the likelihood of successful continuous imaging.

In step S802, the color and shape inspection unit 216 and the gloss inspection unit 217 execute the inspection process. If it is determined in step S801 that the inspection is to be conducted even when an imaging failure image exists (YES in step S802), the consistency relationship is adjusted between captured images and parameters for image combination using the photometric stereo method. The photometric stereo method involves known light source directions. Thus, out of the directions of the light sources stored in advance, the combination of light source directions that correspond to images successfully captured alone are used to generate an inspection image. The subsequent inspection process steps are the same as those in the other exemplary embodiments, and thus the description thereof will be omitted.

As described above, the image processing system 1 in the present exemplary embodiment conducts an inspection even when the number of images captured fluctuates, as long as the conditions that minimally affect the inspection accuracy are satisfied. This further prevents decrease in the yield caused by the inability to conduct an inspection due to a change in the number of images captured.

According to the present disclosure, the decrease in inspection accuracy due to a change in the number of images captured can be prevented.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-040549, which was filed on Mar. 14, 2024 and which is hereby incorporated by reference herein in its entirety.

What is claimed is:

1. An image processing apparatus comprising:
at least one processor; and
at least one memory that is in communication with the at least one processor, wherein the at least one memory stores instructions for causing the at least one processor and the at least one memory to:
acquire captured images obtained by imaging an object;
determine whether a number of the acquired captured images is a reference number for an inspection of the object;
in a case where it is determined that the number of the acquired captured images is the reference number, detect a defect in the object based on the acquired captured images; and
in a case where it is determined that the number of the acquired captured images is not the reference number, output a warning.

2. The image processing apparatus according to claim 1, wherein the at least one memory further stores instructions for causing the at least one processor and the at least one memory to output a result of the inspection.

3. The image processing apparatus according to claim 1, wherein the at least one memory further stores instructions for causing the at least one processor and the at least one memory to detect a defect in the object based on an image obtained by combining the acquired captured images.

4. The image processing apparatus according to claim 3, wherein the at least one memory further stores instructions for causing the at least one processor and the at least one memory to combine the acquired captured images by using a photometric stereo method.

5. The image processing apparatus according to claim 1, wherein the at least one memory further stores instructions for causing the at least one processor and the at least one memory to set the reference number in accordance with an inspection item.

6. The image processing apparatus according to claim 5, wherein the inspection item includes a color, a surface shape, and a gloss.

7. The image processing apparatus according to claim 6, wherein the at least one memory further stores instructions for causing the at least one processor and the at least one memory to set the reference number as one or more in a case where the inspection item is the gloss, and set the reference number as three or more in a case where the inspection item is the color or the surface shape.

8. The image processing apparatus according to claim 1, wherein the at least one memory further stores instructions for causing the at least one processor and the at least one memory to, in a case where it is determined that the number of the images captured acquired is not the reference number, output a warning indicating an inability to conduct the inspection.

9. The image processing apparatus according to claim 1, wherein the at least one memory further stores instructions for causing the at least one processor and the at least one memory to, in a case where the number of the images acquired captured is greater than the reference number and an imaging unit performs continuous imaging, output a warning indicating an abnormality in the imaging unit and displays an indication for prompting an inspection or a recovery of the imaging unit.

10. The image processing apparatus according to claim 1, wherein the at least one memory further stores instructions for causing the at least one processor and the at least one memory to, in a case where the number of the acquired captured images is greater than the reference number, delete excessive images.

11. The image processing apparatus according to claim 1, wherein the at least one memory further stores instructions for causing the at least one processor and the at least one memory to control a conveyance unit to convey the object corresponding to the warning distinguishing the object from an inspected object.

12. An image processing method comprising:
acquiring captured images obtained by imaging an object;
determining whether a number of the acquired captured images is a reference number for an inspection of the object;
detecting a defect in the object based on the acquired captured images in a case where it is determined that the number of the acquired captured images is the reference number; and
outputting a warning in a case where it is determined that the number of the acquired captured images is not the reference number.

13. A non-transitory computer-readable storage medium storing instructions that, when executed by a computer, cause the computer to perform an image processing method, the image processing method comprising:
acquiring captured images obtained by imaging an object;
determining whether a number of the acquired captured images is a reference number for an inspection of the object;
detecting a defect in the object based on the acquired captured images in a case where it is determined that the number of the acquired captured images is the reference number; and
outputting a warning in a case where it is determined that the number of the acquired captured images is not the reference number.
